(19) United States
(12) Patent Application Publication
(10) Pub. No.: US 2025/0323964 A1
(43) Pub. Date: Oct. 16, 2025

(54) VIRTUALIZED HARDWARE BRIDGING SYSTEM AND RELATED METHODS

(71) Applicant: QSC, LLC, Costa Mesa, CA (US)

(72) Inventors: John Dunn, Denver, CO (US); Ryan Pring, Superior, CO (US); Sean Summers, Westminster, CO (US); Josh Arnold, Leo, IN (US)

(21) Appl. No.: 19/178,628

(22) Filed: Apr. 14, 2025

Related U.S. Application Data
(60) Provisional application No. 63/633,975, filed on Apr. 15, 2024.

(51) Int. Cl. H04L 65/65; H04N 23/661

(52) U.S. Cl. CPC H04L 65/65; H04N 23/661

(57) ABSTRACT

A computer-implemented method remotely facilitates exchange of multimedia signals over a network in a teleconferencing environment. The method includes, with a computing device, in real time: receiving input internet protocol (IP) signals from a first peripheral over the network via an IP interface of the computing device; transmitting the input IP signals, via a virtual hardware bridge, to an RTSP server of a virtual display running on the computing device; receiving one or more output IP signals from a teleconferencing application running on the computing device via the virtual hardware bridge; and transmitting the output IP signals to a second peripheral over the network via the network connection.

### PRIORITY

This non-provisional application claims priority to U.S. Provisional Application No. 63/633,975, filed on Apr. 15, 2024, having the same title and inventorship, the disclosure of which is hereby incorporated by reference in its entirety.

### TECHNICAL FIELD

The subject matter described herein relates to systems and methods for virtualized hardware bridging between videoconferencing software and Internet protocol (IP) network peripherals. This virtualized hardware bridging system has particular but not exclusive utility for videoconferencing applications.

### BACKGROUND

Video conferencing rooms may include a unified communications (UC) computer running a videoconferencing application such as Microsoft Teams Room (MTR) or Zoom Rooms (ZR). However, videoconferencing rooms may also include peripherals such as a touchscreen controller (TSC), cameras, microphones, and speakers that are configured to communicate over a network. The videoconferencing applications may not be configured to communicate with these accessories, but rather may expect universal serial bus (USB) video class (UVC) connections. The UC computer may thus require hardware adapters such as Ethernet-to-USB adapters in order to pass signals from the peripherals to the videoconferencing software. Furthermore, videoconferencing rooms may include one or move video displays that receive video signals from the computer over a video cable, such as a High Definition Multimedia Interface (HDMI) cable or DisplayPort cable. Such cables tend to be relatively short, requiring the computer and the video display to be co-located in the same part of the room. Such wiring solutions can be complex, unsightly, and can limit the possible distances and arrangements of equipment within the video conferencing room.

Accordingly, a need exists for improved connectivity and integration solutions that address the forgoing and other concerns.

The information included in this Background section of the specification, including any references cited herein and any description or discussion thereof, is included for technical reference purposes only and is not to be regarded as subject matter by which the scope of the disclosure is to be bound.

### SUMMARY

Disclosed is a virtualized hardware bridging system that provides a virtual sound card, virtual camera, virtual touch, virtual display, etc., within the operating system, that allow the peripheral devices in a videoconferencing room to communicate over a local area network (LAN) and/or a wide area network (WAN) with videoconferencing software, audiovisual room control software, or other applications running on the operating system. For example, a laptop running the virtualized hardware bridging system can be connected to a networked camera over a LAN, and will detect the networked camera as through it were a webcam installed on the laptop and available to all applications running on the laptop.

The computer manager system provides a virtual hardware bridge for one or more software applications running a unified communications (UC) computer, and provides virtual audiovisual (AV) bridging (e.g., a virtual sound card manager, virtual camera manager, virtual content ingest, virtual human interface device (HID, such as a virtual touchscreen interface manager), and a virtual display manager).

The virtualized hardware bridging system disclosed herein has particular, but not exclusive, utility for controlling and integrating the devices in a videoconferencing room.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a computer-implemented method for remotely facilitating exchange of multimedia signals over a network in a teleconferencing environment with a computing device, in real time: receiving input internet protocol (IP) signals from a first peripheral over the network via an IP interface of the computing device; transmitting the input IP signals, via a virtual hardware bridge, to a real-time streaming protocol (RTSP) server of a virtual display running on the computing device; receiving one or more output IP signals from a teleconferencing application running on the computing device via the virtual hardware bridge; and transmitting the output IP signals to a second peripheral over the network via the network connection. Other embodiments of this aspect include corresponding computer systems, apparatus, and computer programs recorded on one or more computer storage devices, each configured to perform the actions of the methods.

Implementations may include one or more of the following features. In some embodiments, the virtual hardware bridge may include: a virtual soundcard manager configured to communicate with a virtual sound driver running on the computing device; a virtual camera manager configured to communicate with a virtual camera driver running on the computing device; a virtual touch manager configured to communicate with a virtual touch driver running on the computing device; and a virtual display manager configured to communicate with a virtual display driver running on the computing device or a real-time streaming protocol (RTSP) server running on the computing device. In some embodiments, the first peripheral and the second peripheral are a single peripheral. In some embodiments, the single peripheral may include a personal computing device or mobile device. In some embodiments, the single peripheral may include a touchscreen controller, where the input IP signals are touch signals, and where the output IP signals are touchscreen controller video signals. In some embodiments, the single peripheral may include a camera, where the input IP signals may include input video signals, and where the output IP signals may include camera control commands at an IP interface of the camera. In some embodiments, the input video signals are compliant with at least one of an h.264 format, motion picture experts group (MPEG) format, Internet Engineering Task Force (IETF) format specified in request for comments (RFC) 4175, or video services forum uncompressed format. In some embodiments, the single peripheral may include a camera, where the input IP signals may include input video signals, and where the output IP signals may include camera control commands and an IP interface of the camera. In some embodiments, the first peripheral may include a microphone, and the input IP signals may include audio input signals. In some embodiments, the second peripheral may include a speaker, and where the output IP signals may include audio output signals. In some embodiments, the second peripheral May include a display or network video decoder, where the output IP signals may include video output signals. In some embodiments, the video output signals are compliant with at least one of an h.264 format, motion picture experts group (MPEG) format, Internet Engineering Task Force (IETF) format specified in request for comments (RFC) 4175, or video services forum uncompressed format. In some embodiments, the computing device is a virtual machine running on a server. In some embodiments, the network is a local area network, and the server is configured to access the local area network via a wide area network. In some embodiments, the server is located in a data center that is not co-located with the first peripheral and the second peripheral.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

One general aspect includes a system for remotely facilitating exchange of multimedia signals over a network in a teleconferencing environment. The system includes a compute manager application running on a computing device and configured to, in real time: receive input internet protocol (IP) signals from a first peripheral over the network via an IP interface of the computing device; transmit the input IP signals, via a virtual hardware bridge, to an RTSP server of a virtual display running on the computing device; receive one or more output IP signals from a teleconferencing application running on the computing device via the virtual hardware bridge; and transmit the output IP signals to a second peripheral over the network via the network connection. Other embodiments of this aspect include corresponding computer systems, apparatus, and computer programs recorded on one or more computer storage devices, each configured to perform the actions of the methods.

In some embodiments, the first peripheral and the second peripheral are a single peripheral. In some embodiments, the first peripheral may include a microphone, and the input IP signals may include audio input signals. In some embodiments, the second peripheral may include a speaker, and the output IP signals may include audio output signals. Implementations of the described techniques may include hardware, a method or process, or computer software on a computer-accessible medium.

One general aspect includes a computer-implemented method for remotely facilitating exchange of multimedia signals over a network in a teleconferencing environment with a computing device, in real time: receiving input internet protocol (IP) signals from a first peripheral over the network via an IP interface of the computing device; transmitting the input IP signals, via a virtual hardware bridge, to a real-time streaming protocol (RTSP) server of a virtual display running on the computing device; receiving one or more output IP signals from a teleconferencing application running on the computing device via the virtual hardware bridge; and transmitting the output IP signals to a second peripheral over the network via the network connection. Other embodiments of this aspect include corresponding computer systems, apparatus, and computer programs recorded on one or more computer storage devices, each configured to perform the actions of the methods.

Implementations may include one or more of the following features. In some embodiments, the virtual hardware bridge may include: a virtual soundcard manager configured to communicate with a virtual sound driver running on the computing device; a virtual camera manager configured to communicate with a virtual camera driver running on the computing device; a virtual touch manager configured to communicate with a virtual touch driver running on the computing device; and a virtual display manager configured to communicate with a virtual display driver running on the computing device or a real-time streaming protocol (RTSP) server running on the computing device.

In some embodiments, the first peripheral and the second peripheral are a single peripheral. In some embodiments, the single peripheral may include a personal computing device or mobile device. In some embodiments, the single peripheral may include a touchscreen controller, where the input IP signals are touch signals, and where the output IP signals are touchscreen controller video signals. In some embodiments, the single peripheral may include a camera, where the input IP signals may include input video signals, and where the output IP signals may include camera control commands to an IP interface of the camera. In some embodiments, the input video signals are compliant with at least one of an h.264 format, motion picture experts group (MPEG) format, internet engineering task force (IETF) format specified in request for comments (RFC) 4175, or video services forum uncompressed format. In some embodiments, the first peripheral may include a microphone, and the input IP signals may include audio input signals.

In some embodiments, the second peripheral may include a speaker, and the output IP signals may include audio output signals. In some embodiments, the second peripheral may include a display or network video decoder, and the output IP signals may include video output signals. In some embodiments, the video output signals are compliant with at least one of an h.264 format, motion picture experts group (MPEG) format, internet engineering task force (IETF) format specified in request for comments (RFC) 4175, or video services forum uncompressed format. In some embodiments, the computing device is a virtual machine running on a server. In some embodiments, the network is a local area network, and the server is configured to access the local area network via a wide area network. In some embodiments, the server is located in a data center that is not co-located with the first peripheral and the second peripheral. Implementations of the described techniques may include hardware, a method or process, or computer software on a computer-accessible medium.

One general aspect includes a computer-implemented method. The computer-implemented method includes, with a server: instantiating a virtual machine running on the server, the virtual machine including a virtual audiovisual bridging component and an audiovisual conferencing application; with the virtual audiovisual bridging component: receiving, over a network, audio, video, control (AVC) signals from at least one first peripheral device located remotely from the server; processing the received AVC signals; directing, via the virtual audiovisual bridging component, a portion of the processed AVC signals with audiovisual signals of the audiovisual conferencing application; and, transmitting, via the virtual audiovisual bridging component, the directed audiovisual signals or the processed AVC signals to a second peripheral located remotely from the server. Other embodiments of this aspect include corresponding computer systems, apparatus, and computer programs recorded on one or more computer storage devices, each configured to perform the actions of the methods.

Implementations may include one or more of the following features. In some embodiments, the at least one first peripheral device and the second peripheral device are a single peripheral. In some embodiments, the single peripheral may include a camera, where the received AVC signals may include input video signals, and where the directed audiovisual signals or the processed AVC signals may include camera control commands to an IP interface of the camera. In some embodiments, the at least one first peripheral device may include a microphone, and the received AVC signals may include audio input signals. In some embodiments, the second peripheral device may include a speaker, and the directed audiovisual signals or the processed AVC signals may include audio output signals. Implementations of the described techniques may include hardware, a method or process, or computer software on a computer-accessible medium.

One general aspect includes a virtual hardware bridge configured to, with a computing device, in real time: transmit input IP signals to an RTSP server of a virtual display running on the computing device; and receive one or more output IP signals from a teleconferencing application running on the computing device, where the virtual hardware bridge may include: a virtual soundcard manager configured to communicate with a virtual sound driver running on the computing device; a virtual camera manager configured to communicate with a virtual camera driver running on the computing device; a virtual touch manager configured to communicate with a virtual touch driver running on the computing device; and a virtual display manager configured to communicate with a virtual display driver running on the computing device or a real-time streaming protocol (RTSP) server running on the computing device. Other embodiments of this aspect include corresponding computer systems, apparatus, and computer programs recorded on one or more computer storage devices, each configured to perform the actions of the methods.

This Summary is provided to introduce a selection of concepts in a simplified form that are further described below in the Detailed Description. This Summary is not intended to identify key features or essential features of the claimed subject matter, nor is it intended to limit the scope of the claimed subject matter. A more extensive presentation of features, details, utilities, and advantages of the UC compute manager, as defined in the claims, is provided in the following written description of various embodiments of the disclosure and illustrated in the accompanying drawings.

### BRIEF DESCRIPTION OF THE DRAWINGS

Illustrative embodiments of the present disclosure will be described with reference to the accompanying drawings, of which:

FIG. 1 is a schematic, diagrammatic representation of an example videoconferencing room, in accordance with at least one embodiment of the present disclosure.

FIG. 2 is an abstract schematic, diagrammatic representation of at least a portion of an example virtualized hardware bridging system, in accordance with at least one embodiment of the present disclosure.

FIG. 3 is a schematic, diagrammatic representation, in block diagram form, of an example compute manager, in accordance with at least one embodiment of the present disclosure.

FIG. 4 is a schematic, diagrammatic representation, in block diagram form, of an example videoconferencing room, in accordance with at least one embodiment of the present disclosure.

FIG. 5 is a schematic, diagrammatic representation, in block diagram form, an example videoconferencing room without a virtualized hardware bridging system, in accordance with at least one embodiment of the present disclosure.

FIG. 6 is a schematic, diagrammatic representation, in block diagram form, an example videoconferencing room with a virtualized hardware bridging system, in accordance with at least one embodiment of the present disclosure.

FIG. 7 is a schematic, diagrammatic representation, in block diagram form, an example videoconferencing room with a virtualized hardware bridging system, in accordance with at least one embodiment of the present disclosure.

FIG. 8 is a schematic, diagrammatic representation, in block diagram form, an example videoconferencing room with a virtualized hardware bridging system, in accordance with at least one embodiment of the present disclosure.

FIG. 9 is a schematic, diagrammatic representation, in block diagram form, an example videoconferencing room with a virtualized hardware bridging system, in accordance with at least one embodiment of the present disclosure.

FIG. 10 is a schematic diagram of a processor circuit, according to embodiments of the present disclosure.

FIG. 11 shows a flow diagram of an example multimedia information exchange method according to at least one embodiment of the present disclosure.

FIG. 12 shows a flow diagram of an example multimedia information exchange method according to at least one embodiment of the present disclosure.

FIG. 13 shows a flow diagram of an example multimedia information exchange method according to at least one embodiment of the present disclosure.

### DETAILED DESCRIPTION

In accordance with at least one embodiment of the present disclosure, a virtualized hardware bridging system is provided which allows the peripheral devices in a videoconferencing room to communicate over a local area network (LAN) and/or a wide area network (WAN) with software that expects USB UVC communications. The computer manager system provides an Internet protocol (IP) virtual hardware bridge for one or more videoconferencing software applications (e.g., MTR, ZR, etc.) running on the unified communications (UC) computer. The virtualized hardware bridging system provides virtual audiovisual (AV) bridging (e.g., a virtual sound card manager in communication with a virtual sound driver, a virtual camera manager in communication with a virtual camera driver, virtual content ingest, virtual human interface device (HID, such as a virtual touchscreen interface manager in communication with a virtual touch driver), a virtual display manager in communication with a virtual display driver and a real-time streaming protocol (RTSP) server, and a user control interface (UCI) viewer.

Examples of hardware-based AV bridging may be found for example in U.S. Pat. No. 9,973,638, filed 26 Jun. 2016, incorporated by reference as though fully set for herein. Examples of audio, video, and control systems implementing virtual machines may be found for example in U.S. Application No. 2022/0391269, filed 22 Aug. 2022, incorporated by reference as though fully set forth herein.

The virtualized hardware bridging system may for example be a software application. Virtualized hardware bridging removes the restrictions inherent from having local, distance-limited, point-to-point wiring connections (USB camera, USB input for HDMI, HDMI output). These hard-wired connections can instead be replaced with network-based virtual connections to the AV peripherals (e.g., cameras, microphones, speakers, displays, touch screen controllers, etc.), allowing the UC computer to be more flexibly located within a physical space or facility.

The virtualized hardware bridging system may be used to address multiple use cases found in audio-visual applications. One such use case applies to collaboration spaces featuring videoconferencing with modern unified communications (UC) software applications. Another such use case involves the network distribution of software based digital signage presented on displays located in a variety of locations such as, for example, inside malls, cruise ships, stadiums, hotels, or along roadways, etc. The displays may be activated using, for example, touch-based activation or proximity-based activation. Still another use case involves wired or wireless screen sharing from a personal computing device (PC) of an application running on the UC computer.

Within collaboration spaces equipped with dedicated UC computer hardware and software, a compute device running the virtualized hardware bridging system enables the PC to comprehensively integrate virtual AV devices on the UC computer to network-connected AV hardware peripherals (microphones, cameras, speakers, touch screen controllers, etc.). These systems may for example be found in corporate or educational institutions, large meeting rooms, training rooms, lecture halls, and classrooms.

The virtualized hardware bridging system includes functionality that virtualizes the primary user control interface of modern UC teleconferencing and room control system applications such as Microsoft Teams, Microsoft Teams Room, Zoom, or Zoom Rooms, allowing the end user to have flexible options for controlling the UC room control application (meeting start, audio levels, camera control, environment controls, etc.) from one or multiple networked touchscreen controllers located within the meeting space. These controllers are network connected to allow for flexible physical placement within physically larger collaboration spaces. In rooms that benefit from the use of multiple touchscreen controllers, the virtualized hardware bridging system provides an ability to accept remote touchscreen input (e.g., user touch events) to the UC room control application from one or more of the touch screen controllers. In an example, a room control application starts meetings, and the and the virtualized hardware bridging system provides control of the application, starts the audio levels, camera control, environmental control, etc. Each of these control commands can be received from the touch screen controller via the network to the virtual touch controller running on the UC computer.

Some collaboration spaces feature the ability to reconfigure the room layout (typically called divisible rooms or divisible meeting spaces) through the addition or removal of temporary room dividers and/or air walls. The virtualized hardware bridging system provides logic to allow flexible remapping of the controller display and touch events when these rooms are reconfigured. For example, when two or more rooms are combined, multiple controllers in the room provide easy access to control a single UC application running on the UC computer. When the rooms are divided, each smaller room may be equipped with a dedicated UC computer and UC application, or multiple rooms may be serviced by different instances of the compute manager running on a single computer. In this configuration, it is likely that each room has a single touch screen controller. The virtualized hardware bridging system provides functionality to remap the touch screen to UC application connectivity, and may be configured as a divisible space such that when dividing walls are opened or closed, the configuration of the system automatically adapts. Thus, for example, the computing core may hold a single room design that allows for both a single room (open-wall) or multi-room (closed-wall) configuration.

In the digital signage use case, the source for the virtual display does not always need to be the UC computer; it could instead be a digital signage type application or other application capable of running on a PC. The virtualized hardware bridging system can be installed on a non-UC computer (e.g., a personal computer or laptop), so that content can be pushed through to a shared display.

In the personal device screen-sharing use case, the screen of a personal device (e.g., a laptop or notebook PC, or other device capable of running an operating system that supports the compute manager) that is communicatively coupled to the UC computer running the virtualized hardware bridging system can be shared to a display that is connected to the UC computer, either directly (e.g., via an HDMI cable) or via the network. Further, personal device may manage and control an application running on the UC computer as if the application were running on the personal device, as described in detail below.

The features of the virtualized hardware bridging system include virtual display, virtual human interface device (HID), UCI viewer (second page experience), multi-camera streaming, virtual AV bridging, and an ability to stream primary display outputs to a touch screen controller or other LAN-based electronic device that provides a display and touchscreen. “Second page experience” is a Microsoft term for room controls. Room controls are a way for a user to adjust parameters such as sound levels, echo-cancelling, etc. The virtualized hardware bridging system runs a UCI to control the second page experience.

The virtualized hardware bridging system includes functionality to address the requirements of network based virtual AV bridging (e.g., streaming of network audio/video content) and virtual display functionality (e.g., streaming of a computer's display output). The virtualized hardware bridging system uses encrypted control communications for both configuration and monitoring.

The virtualized hardware bridging application manages lower level drivers that are used to deliver the virtual AV bridging and virtual display functionality. These drivers include, for example, a virtual display daemon instance, management of a virtual HID driver, management of a virtual camera driver, and management of a virtual audio driver if required.

The virtual display driver component is used to manage a software-based display, and includes two main parts—a driver to instantiate the display and the encoding (e.g., h.264) and transmission of the display content to a network-based touch screen controller. The following parameters of the virtual display driver may be configurable: an enabled/disabled status; the resolution/and/or frame rate of the virtual display; the 264 encoding parameters; and the IP address and port destination of encoded content. Depending on the implementation, the IP address and port destination may need to be dynamic (e.g., dynamically changeable at runtime). The RTSP server of the virtual display supports both unicast and multicast addressing schemes.

The virtualized hardware bridging system can also instantiate a virtual HID driver that can receive HID events (e.g., touch events) from a touch screen controller (TSC) over the network. The TSC that is being received can be dynamically changed at runtime. One or more virtual webcams can be instantiated and controlled by the virtualized hardware bridging system. For each camera instantiated, the virtualized hardware bridging system will receive an RTSP video stream. The address of the stream can be dynamically changed at runtime. The virtualized hardware bridging system can instantiate an instance of a bi-directional virtual audio device.

The system may also be used in a virtual content ingestion configuration, where a user may bring their own PC (e.g., a laptop or notebook computer) to a meeting, and connect the user's PC to the audiovisual control (AVC) system. In this variation, the PC running the UC application is connected to both the user's PC and the room display, and content from the user's PC is sent via a video encoder to the virtualized hardware bridging application. The video content is then decoded within the virtualized hardware bridging application, and is presented to the UC application as a dedicated virtual content ingestion device.

Other use cases include virtual AV bridging. For example, a UC computer running both the UC application and the virtualized hardware bridging application includes a virtual camera, thus obviating the need for a network encoder to be placed near the UC computer. This enables the UC computer to be located in a conference room or remotely in a server rack. This is enabled by creating a virtual camera made available within the UC computer, where the UC computer may transmit signals over the network, for example, from a server rack in a separate room from the conference room, to the decoder connected to a shared display located in the conference room. Further, the UC computer may receive the camera streams remotely over the network to enable the virtual camera within the UC computer.

Rather than requiring the virtual display to be routed to an encoder, or the physical display to be connected via a physical video cable, the virtualized hardware bridging system allows an Ethernet and power cable and/or power-over-Ethernet cable for the UC computer running a UC application and virtualized hardware bridging application. Still another use case involves the UC computer running multiple machine instances, with a UC application and virtualized hardware bridging application running on each virtual machine instance. The UC computer can also be located remotely in a cloud environment.

The present disclosure aids substantially in integrating and controlling audiovisual (AV) accessories (displays, microphones, speakers, touchscreen controllers, etc.), by improving their ability to communicate over a network, without bulky hardware conversion solutions. Implemented on a unified communications (UC) computer in communication with multiple peripherals over an IP local area and/or wide area network, the virtualized hardware bridging system disclosed herein provides practical replacement of AV bridging hardware with a virtual AV bridge running on the UC computer itself. This virtualized bridging transforms a hardware solution into one that can be performed entirely in software, without the normally routine need to connect IP network cables, HDMI cables, and USB cables into a hardware bridge. This unconventional approach improves the functioning of the UC computer, by allowing it to communicate directly with AV peripherals over the IP network.

The virtualized hardware bridging system may be implemented as a process at least partially viewable on a display, and operated by a control process executing on a processor that accepts user inputs from a keyboard, mouse, or touchscreen interface, and that is in communication with one or more networked peripherals. In that regard, the control process performs certain specific operations in response to different inputs or selections made at different times. Certain outputs of the virtualized hardware bridging system may be printed, shown on a display, or otherwise communicated to human operators. Certain structures, functions, and operations of the processor, display, peripherals, and user input systems are known in the art, while others are recited herein to enable novel features or aspects of the present disclosure with particularity.

These descriptions are provided for exemplary purposes only, and should not be considered to limit the scope of the virtualized hardware bridging system. Certain features may be added, removed, or modified without departing from the spirit of the claimed subject matter.

For the purposes of promoting an understanding of the principles of the present disclosure, reference will now be made to the embodiments illustrated in the drawings, and specific language will be used to describe the same. It is nevertheless understood that no limitation to the scope of the disclosure is intended. Any alterations and further modifications to the described devices, systems, and methods, and any further application of the principles of the present disclosure are fully contemplated and included within the present disclosure as would normally occur to one skilled in the art to which the disclosure relates. In particular, it is fully contemplated that the features, components, and/or steps described with respect to one embodiment may be combined with the features, components, and/or steps described with respect to other embodiments of the present disclosure. For the sake of brevity, however, the numerous iterations of these combinations will not be described separately.

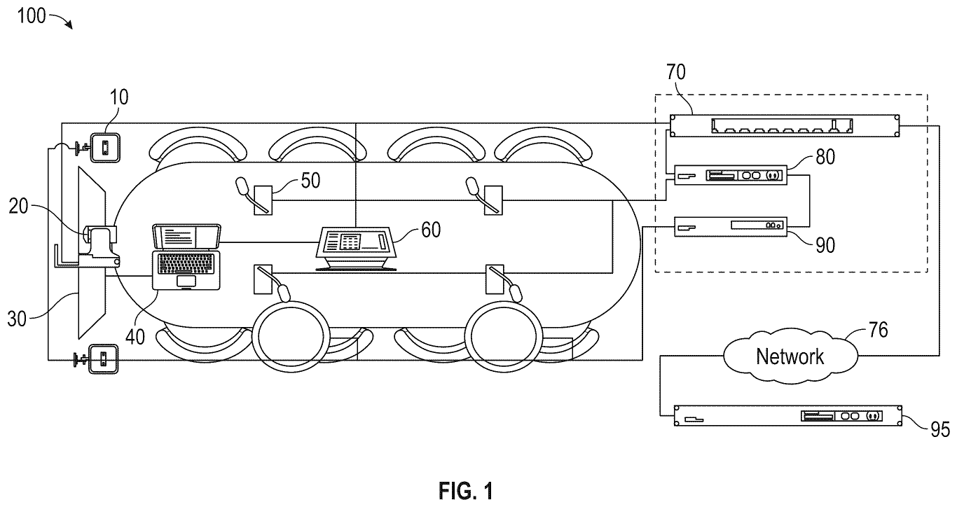

FIG. 1 is a schematic, diagrammatic representation of an example videoconferencing room 100, in accordance with at least one embodiment of the present disclosure. In the example shown in FIG. 1, the videoconferencing room 100 includes speakers 10, a camera 20, a video display 30, personal computer 40, microphones 50, touch screen controller 60, a network switch 70, amplifier 90, corporate network 76, and processor 95. The videoconferencing room 100 also includes a hardware bridge 80 to translate between USB connections and IP network (e.g., Ethernet) connections.

Before continuing, it should be noted that the examples described above are provided for purposes of illustration, and are not intended to be limiting. Other devices and/or device configurations may be utilized to carry out the operations described herein.

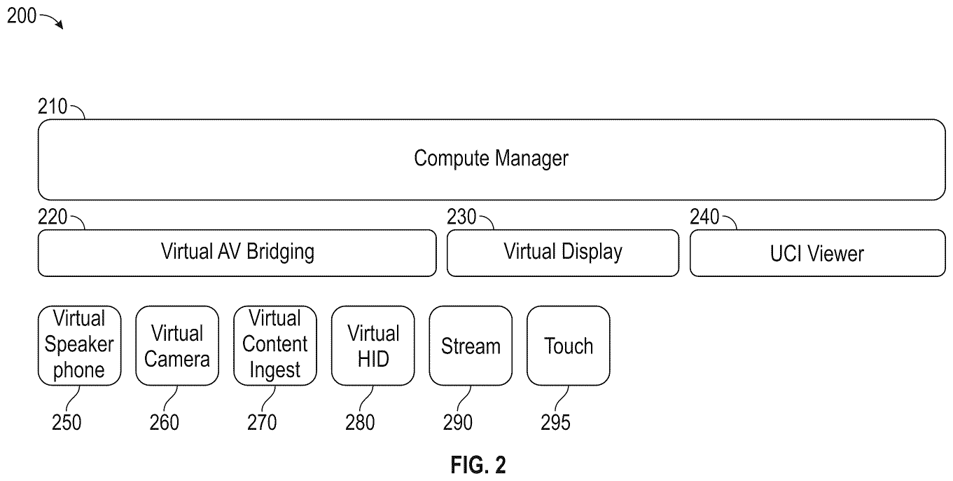

FIG. 2 is an abstract schematic, diagrammatic representation of at least a portion of an example virtualized hardware bridging system 200, in accordance with at least one embodiment of the present disclosure. In the example shown in FIG. 2, the virtualized hardware bridging system 200 includes the compute manager 210, with virtual AV bridging 220 that includes bridging to a virtual speakerphone 250, virtual camera 260, virtual content ingest 270, and virtual human interface device (HID) 270. The virtualized hardware bridging system 200 also includes a virtual display 230 that can both stream 290 to a touchscreen controller and receive touch inputs 295 from the touch screen controller. The virtualized hardware bridging system 200 also includes a user control interface (UCI) viewer 240.

In the example shown in FIG. 2, the compute manager 210 includes functionality to address the requirements of network based virtual AV bridging (streaming of network audio and/or video content) and virtual display functionality (streaming of the UC computer's display output). In an example, the compute manager 210 uses encrypted control communications for both configuration and monitoring. The compute manager 210 manages lower-level drivers that are used to deliver the virtual AV bridging and virtual display functionality. These drivers include a virtual display daemon instance (e.g., virtual display 230), management of a virtual HID driver 280, management of a virtual camera driver 280, etc.

The compute manager 210 offers a virtual display feature (e.g., virtual display manager 438) that streams an MTR or ZR controller user interface from the PC directly over the network 550 to the touch screen controller 160, allowing network flexibility for collaboration spaces that may be larger than the videoconferencing room 600 itself. The compute manager 210 is distance agnostic, in that it can send and receive signals over the network, regardless of the size or configuration of the room. Also, there is a one-to-many relationship in that a single compute manager can interact with many peripherals. The compute manager 210 is reconfigurable to a different set of peripherals, for example, in the case of divisible spaces.

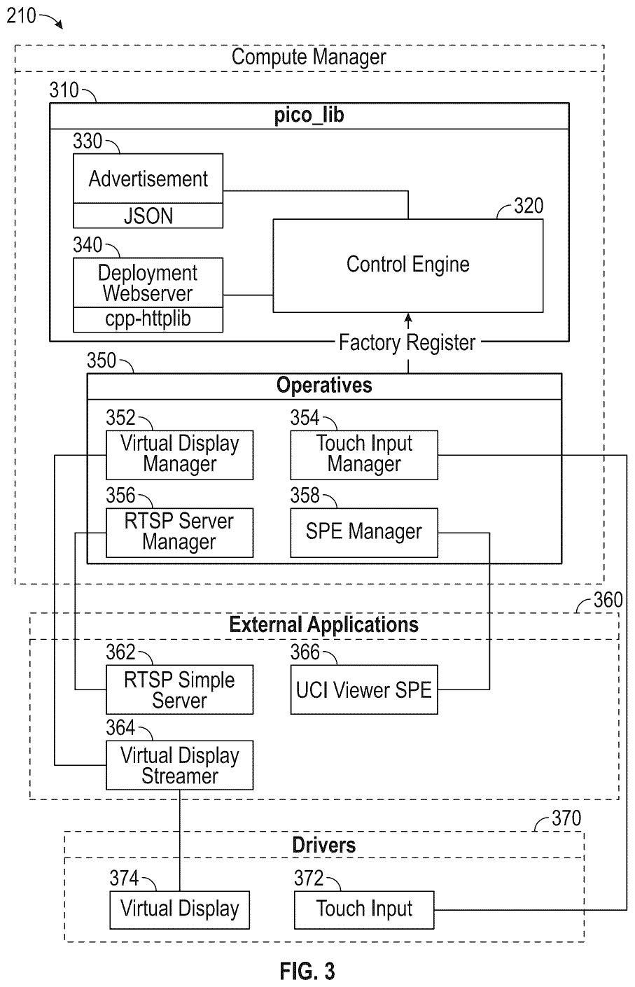

FIG. 3 is a schematic, diagrammatic representation, in block diagram form, of an example compute manager 210, in accordance with at least one embodiment of the present disclosure. In the example shown in FIG. 3, the compute manager 210 includes a pico library 310, which includes a control engine 320, an advertisement Javascript Object Notation (JSON) module 330, and deployment webserver 340. The compute manager 210 also includes operatives 350, that include the virtual display manager 352, RTSP server manager 356, touch input manager 354, and second page experience (SPE) manager 358. An operative 350 is a piece of code that controls a process.

The compute manager 210 is in communication with external applications 360 and drivers 370 that are also running on the UC computer. For example, the virtual display manager 352 is in communication with a virtual display streamer 364 that communicates with a virtual display driver 374. The RTSP server manager 356 is in communication with an RTSP server 362. The touch input manager 354 is in communication with a touch input driver 372, and the SPE manager 358 is in communication with a UCI viewer SPE 366.

Block diagrams are provided herein for exemplary purposes; a person of ordinary skill in the art will recognize myriad variations that nonetheless fall within the scope of the present disclosure. For example, any of the blocks described herein may optionally include an output to a user of information relevant to the block, and may thus represent an improvement in the user interface over existing art by providing information not otherwise available.

Similarly, block diagrams may show a particular arrangement of components, modules, services, steps, blocks, processes, or layers, resulting in a particular data flow. It is understood that some embodiments of the systems disclosed herein may include additional components, that some components shown may be absent from some embodiments, and that the arrangement of components may be different than shown, resulting in different data flows while still performing the methods described herein.

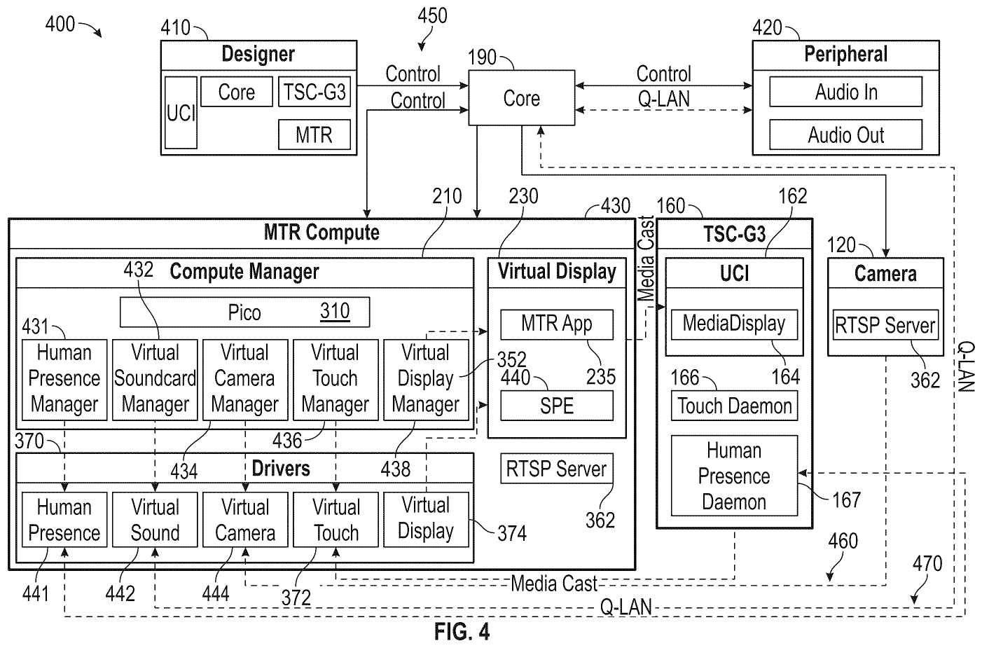

FIG. 4 is a schematic, diagrammatic representation, in block diagram form, of an example videoconferencing room 400, in accordance with at least one embodiment of the present disclosure. In the example shown in FIG. 4, the videoconferencing room 400 includes an application designer 410, processor core 190, peripheral(s) 420 (e.g., a microphone, speaker, etc.), camera 120 with RTSP server 362, and a touch screen controller 160 with a UCI 162, media display 164, and touch daemon 166. The videoconferencing room 400 also includes a UC computer 430, that runs the computer manager 210, virtual display 230, RTSP server 362, and drivers 370.

The virtual display 230 includes a videoconferencing application 235 (e.g., Microsoft Teams Room or Zoom Rooms) and an SPE 440. The compute manager 210 includes the pico library 310, as well as a human presence manager 431 in communication with a human presence driver 441, a virtual sound card manager 432 in communication with a virtual sound driver 442, a virtual camera manager 434 in communication with a virtual camera driver 444, a virtual touch manager 436 in communication with a virtual touch driver 372, and a virtual display manager 438 in communication with the virtual display 230.

The human presence driver 441 is in communication with touch screen controller 160 via a human presence daemon 167 over any suitable network connection. A suitable proximity sensor is communicably coupled to human presence manager 431 to sense the presence of a person inside videoconferencing room 400. Once the person is sensed, human presence driver 441 “wakes up” UC Computer 430. In other illustrative embodiments, human presence manager 431 can also wake up peripherals on the network.

The virtual sound driver 442 is in communication with the peripheral(s) 420 via the core 190 over an IP network connection 470. The virtual camera driver 444 is in communication with the RTSP server 362 of the camera 120 via a MediaCast connection, for example, or RTSP video stream 460. The virtual touch driver 372 is in communication with the touch daemon 166 of the touch screen controller 160. The virtual display driver 374 is in communication with the virtual display 230, which is in communication with the touch screen controller 160 via a MediaCast link 460. The application designer 410 is in communication with the core 190 and UC computer 430 via control connections 450. The core 190 is also in communication with the peripheral(s) 420 via a control connection 450.

In the example shown in FIG. 4, devices are connected by combinations of control connections 450, MediaCast connections 460, and/or IP network connections 470.

In an example, the application designer 410 is an open-architecture AV design software application downloadable on a user device (e.g., a laptop PC), where a user can construct a design for an AVC system, including processor and peripherals, that acts as instructions for AV processing and routing thereof. The design is sent from the user device to the audio/video/control processor. In an example, the AV peripherals, the processor, the UC computer, and the other compute devices are connected via an Ethernet network.

The architecture shown in FIG. 4 can include a one-to-many scenario, where there is one compute manager 210 that provides virtual display that can be routed to multiple touch screen controllers 160. Alternatively, the architecture shown in FIG. 4 can include a many-to-one scenario, such as in a divisible meeting space having multiple conference rooms that can be combined/divided into a subset of spaces. Multiple touchscreens in a combined space can be mirrored to provide control over the same UC computer 430. When the space is divided, the touchscreens 160 can be mapped 1:1 to the additional UC computer 430 in each subdivided space.

One of the advantages of this arrangement is that the primary display(s) of the room (e.g., not the touchscreen controller, as shown above, but a shared display in a conference room) can also stream audio and video through the UC computer, eliminating the need for external hardware (e.g., a codec) on the encode side.

The virtual display manager is instructing the RTSP server where to send the video signals that 1) have been received over the WAN (e.g., remotely over the Internet) from the far end and 2) the video signals that have been received, over the LAN, from the network video cameras 120 located at the near end.

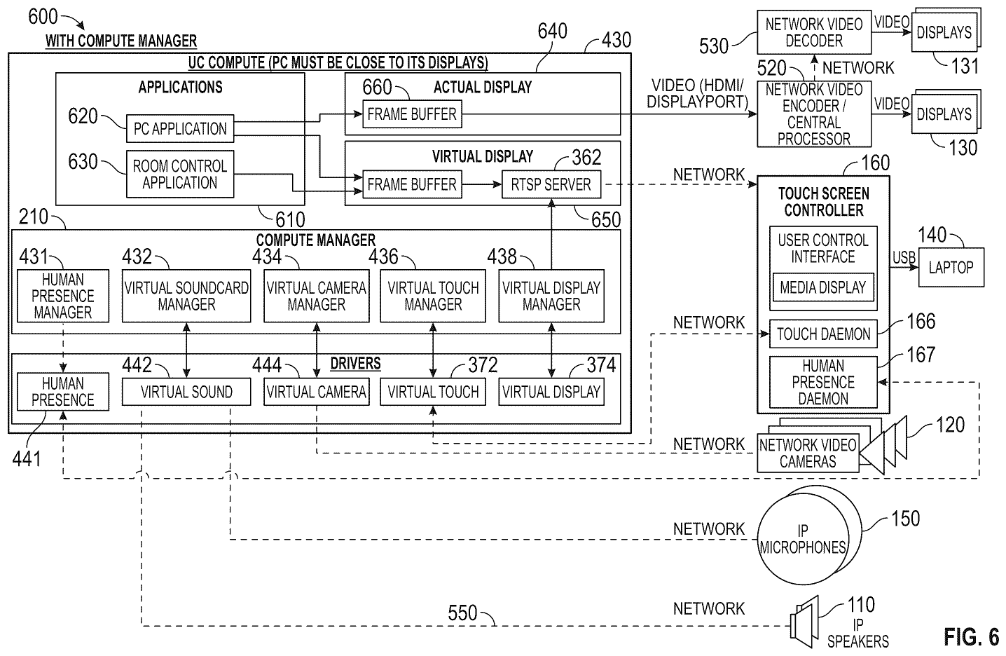

When virtual camera 444 receives video signals over the LAN from network video cameras 120, the virtual camera manager 434 facilitate the relationship between the application(s) running on the UC computer 430 and the virtual camera 444 for the hand-off of those video signals from the virtual camera 444 and application(s) 610 (see FIG. 6).

The application(s) 610, via the compute manager 210, will then send those video signals to frame buffers 660 (see FIG. 6), to either transmit, via RTSP servers 362, to the room displays 131, 130, or to touch screen controller 160. The RTSP server 362 both serves and syncs both video signals from the near-end and far-end for display within a same display.

The same is true for audio signals, which may for example be transmitted from IP microphones to the virtual sound driver 442. Virtual soundcard manager 432 facilitates a relationship between the application 610 (see FIG. 6) and the virtual sound driver 442 for handing off captured audio signals. The audio signals may be transmitted by the application 610 to the top frame buffer 660 to the RTSP server 362 for transmission to the displays 130, 131, for example, when there is no sound sent to the touch screen controller 160.

Further, with regard to control signals, the virtual touch manager 436 may facilitate a relationship between the virtual touch driver 372 and the application 610 for handing off control signals received by the touch screen controller 160. Control signals may be transmitted to the bottom frame buffer via room control application 630 over the LAN to the touch screen controller 160.

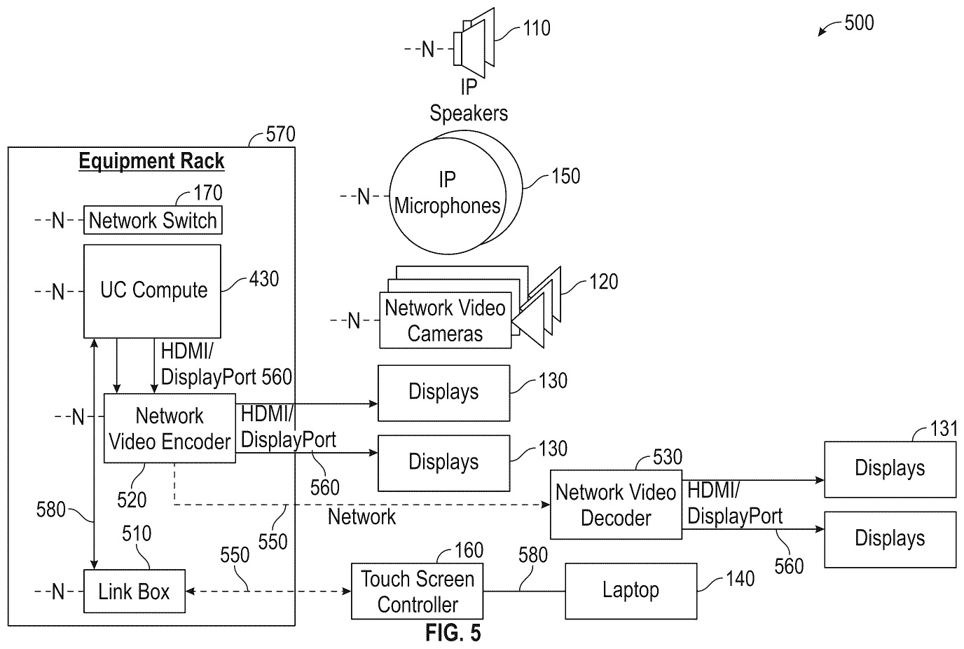

FIG. 5 is a schematic, diagrammatic representation, in block diagram form, an example videoconferencing room 500 without a virtualized hardware bridging system, in accordance with at least one embodiment of the present disclosure. In the example shown in FIG. 5, the speakers 110, microphones 150, and cameras 120 are all connected to a local area network N, 550. An equipment rack 570 holds the network switch 170, UC compute 430, a network video encoder 520, and link box 510.

The link box 510 is a special interface that facilitates transfer of control signals between the touch screen controller 160, microphones 150, etc., which send signals over the network 550 to the link box, which then sends those signals to the UC computer over the network 550 or a separate wired connection.

The network switch 170, UC compute or UC computer 430, network video encoder 520, and link box or hardware bridge 510 are all connected to the network N, 550. The link box 550 is connected to the UC compute 430 via a USB UVC connection 580, that enables networked peripherals such as the speakers 110 and microphones 150 to communicate with the videoconferencing applications running on the UC compute. The link box or hardware bridge 510 is also connected to the touch screen controller 160 via the network N, 550, and the touch screen controller 160 is connected to the personal computer 140 via a USB UVC connection.

The network video encoder 520 is connected to the UC computer 430 via video cables 560 (e.g., HDMI and/or DisplayPort cables), and is connected to a first set of displays 130 via video cables 560. These displays must be close to the equipment rack 570, because they are limited by the length of the video cables 560. However, the network video encoder 520 can also communicate with a network video decoder 530 over the network N, 550. The network video decoder 530 then communicates with additional video displays 131 via video cables 560. These additional video displays 131 must be close to the network video decoder 530 (again, limited by the length of the video cables 560), but may be distant from the equipment rack 570, because the network 550 allows much greater freedom to position equipment.

FIG. 6 is a schematic, diagrammatic representation, in block diagram form, an example videoconferencing room 600 with a virtualized hardware bridging system, in accordance with at least one embodiment of the present disclosure. In the example shown in FIG. 6, there is a software compute manager 510 running on the UC computer 430.

In the example shown in FIG. 6, applications 610 running on the UC computer 430 include PC applications 620 (including not only videoconferencing applications, but any other PC application that can access A/V peripherals) and a room control application 630 (e.g., Microsoft Teams Room or Zoom Rooms). The PC application 620 communicates with frame buffers 660 within both an actual display 640 and a virtual display 650. The virtual display 650 also includes an RTSP server 362. The room control application 630 also communicates with the frame buffer 660 of the virtual display 650. The RTSP server 362 is in communication with the touch screen controller 160 via the network, and the touch screen controller 160 is in communication with the laptop or personal computer 140 via a USB connection.

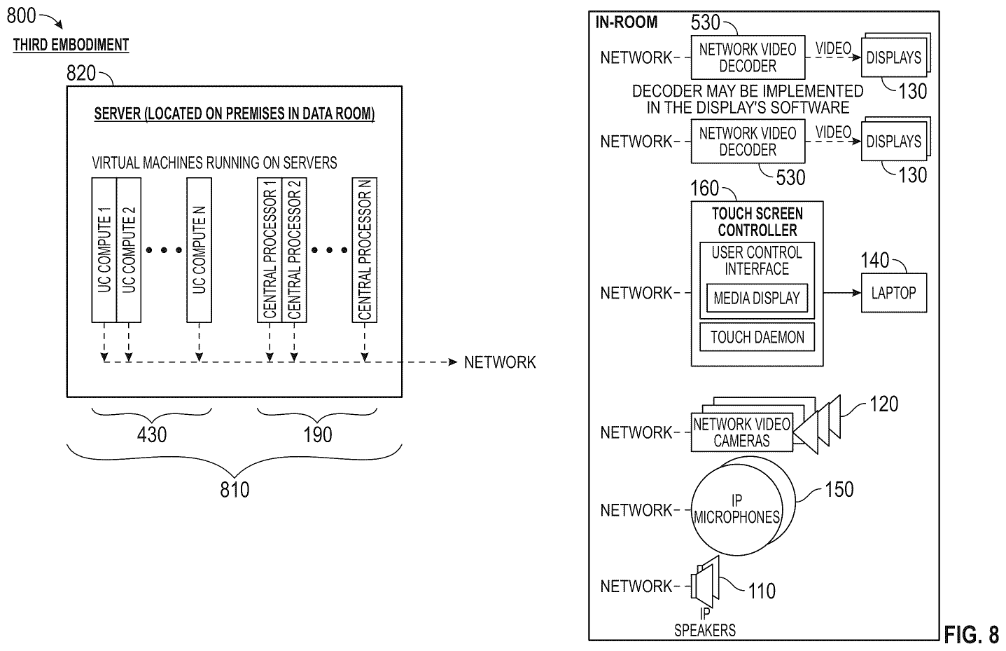

In an example, virtual display 650 operates at the top layer or application layer of the operating system, whereas virtual display 347 operates at the lowest level or driver level of the operating system, with the compute manager 210 serving as a middleware layer providing services to other applications 620, 630. The compute manager 210 is talking to the operating system, but it's also talking to a core 190 (see FIG. 1 or FIG. 8) that contains the room design. Every time the system boots up or starts up, the compute manager 210 will talk to the core to fetch instructions regarding the system configuration, which are resident on the core. These instructions may for example be included in a design file that was either automatically created based on the peripherals, or else manually created by a technician.

As in FIG. 5, the network video encoder 520 is connected to the UC computer 430 via video cables (e.g., HDMI and/or DisplayPort cables), and is connected to a first set of displays 130 via video cables. The network video encoder 520 can also communicate with a network video decoder 530 over the network. The network video decoder 530 then communicates with additional video displays 131 via video cables 560.

However, the touch daemon 166 of the touch screen controller 160 communicates, via the network, with the virtual touch driver 372 running on the UC computer 430, and the virtual touch driver 372 communicates with the virtual touch manager 436 of the compute manager 210. The human presence daemon 167 of the touch screen controller 160 communicates, via the network, with the human presence driver 441 running on the UC computer 430, and the human presence driver 441 communicates with the human presence manager 431 of compute manager 210. Similarly, the video cameras 120 communicate over the network with the virtual camera driver 444, which communicates with the virtual camera manager 434 of the compute manager 210. The microphones 150 and speakers 110 communicate over the network with the virtual sound driver 442, which communicates with the virtual soundcard manager 432 of compute manager 210. The compute manager 210 communicates with the applications 610 in that it provides drivers with which the applications 610 can interface with the peripherals.

In an example, the compute manager 210 can be thought of as the sum of its independent managers 432, 434, 436, 438, etc. The compute manager 210 facilitates the relationship between the applications 620, 630 and the drivers 442, 444, 372, 374. For example, the audio, video, and control signals may be sent from the drivers (received from their respective peripherals) to the applications 610, after the respective manager has established the relationship between the driver and application 610. Virtual display manager 438 will tell the RTSP server 362 in virtual display 650 where to send the audio, video, or control signals, e.g., to the displays or the touch screen controller.

In another example, the virtual camera manager 434 sets up the virtual camera 444 for the room, and receives a video stream from the camera 120, and then it hands that to application 610 as a camera input.

In an example, the compute manager 210 may receive input IP signals from a first peripheral (e.g., a microphone) and transmit output IP signals to a second peripheral (e.g., a speaker), or may send and receive IP signals to and from a single peripheral (e.g., a personal computer, touchscreen controller, or camera). Output signals to a camera may include camera control commands (e.g., pan, zoom, tilt, or focus commands) and an IP interface of the camera. Depending on the implementation, control commands may be sent to other peripherals as well, including but not limited to microphones, speakers, touchscreen controllers, computers, mobile devices, and displays.

Input video signals (e.g., from a camera) and output video signals (e.g., to a display) may be compliant with at least one of an H.264 format, Motion Picture Experts Group (MPEG) format, Internet Engineering Task Force (IETF) format specified in Request for Comments (RFC) 4175, Video Services Forum uncompressed format, AVC, HEVC (H.265), VP9, AV1, MPEG-2, VC-1, MJPEG (Motion JPEG), MPEG-4, AVI (Audio Video Interleave), DivX, Xvid, WMV (Windows Media Video), Theora, RV (RealVideo), ProRes, DNxHD (Avid DNxHD), H.263, H.261, H.262 (MPEG-2 Part 2), FLV (Flash Video), WebM, MPEG-1, Cinepak, QuickTime, FFVI (FFmpeg Video Codec 1), and other formats familiar to a person of ordinary skill in the art.

In some cases, the network video decoder 530 may be a component of the video displays 131. Network video decoder 520 or 530 may be hardware or software based and, in the case of the latter, may be installed during manufacturing or downloaded and/or updated after manufacturing.

Although the compute manager 210 can be used in the context of MTR and ZR, this software can be used to remotely control an application (e.g., MTR or ZR) installed and/or running on one device (e.g., laptop, desktop computer, and the like) from one or more other devices that are displaying the application within their own UI. For example, although applications 610 are running on UC compute 430, touch screen controller 160 can send and receive any of audio, video, or control signals, via Compute Manager 210 and associated managers/drivers, as if applications 610 were running on touch screen controller. In other words, Compute Manager 430, among other things, can natively incorporate any device to the system and further manage and facilitate audio, video, and control signals with the device in such a way as to allow the device to control the applications 610 as if the applications 610 were running on the device, rather than Compute Manager 430.

The Compute Manager can accept an encrypted control connection from a core processor for both configuration and monitoring; manage the UCI Viewer instance if required; manage the Virtual Display Daemon instance; manage Virtual HID from TSC Touch events; manage the Virtual Camera Driver if required; and manage the Virtual Audio Driver if required.

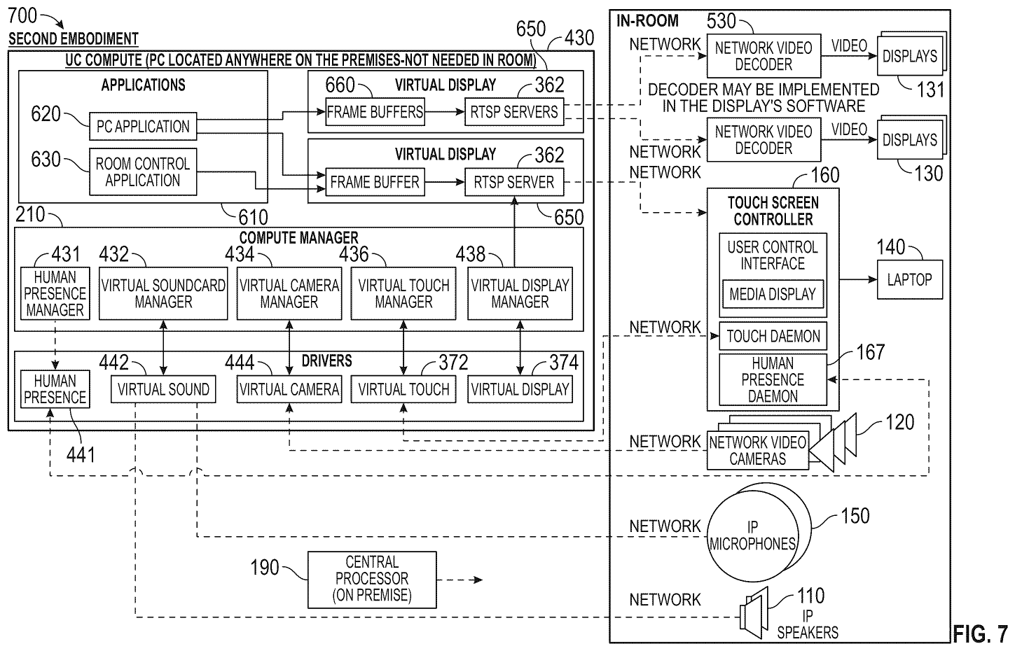

FIG. 7 is a schematic, diagrammatic representation, in block diagram form, an example videoconferencing room 700 with a virtualized hardware bridging system, in accordance with at least one embodiment of the present disclosure. FIG. 7 is similar to FIG. 6, except that there is no actual display 640, and there is no video cable connecting the network video decoder 530 to the UC computer 430. Rather, both network video decoders 530 communicate over the network with RTSP servers 362 of the virtual display. Thus, the room displays 130 and 131 can all be positioned anywhere in the room, limited only by the positions of the network video decoders 520, and not limited by the position of the UC compute 430. In some cases, the network video decoder 530 may be a component of the video displays 131.

The videoconferencing room 700 of FIG. 7 also includes a central processor 190, that is located on the premises (e.g., within the local area network) but not necessarily in the videoconferencing room itself. The core or central processor 190 sends the compute manager 210 a design file, that includes which peripherals comprise the AVC setup. In the case of divisible rooms, this may include several, disparate AVC setups for when the divisible space reconfigures. For example, there may be three AVC setups included within the design file, one for each divisible room configuration. The design file may also specify the algorithms/data processing to be performed by the processor. For example, before any of audio, video, or control signals are sent to the compute manager 210, or after, the core or central processor 190 may perform various types of signal processing on the audio, video, or control signals. Processing may for example include gain and level adjustments, acoustic echo reduction or cancellation, mixing, encoding/decoding, resolution adjustments, cropping, delay control, voice over internet protocol/session initiation protocol (VOIP/SIP) interface control, input control, etc. Also, based on the design file, the core or central processor 190 may instruct the compute manager 210 where to send signals, for example, to which displays within the room or within a specific AVC setup.

The UC computer, running both the UC application 620 and the compute manager 210, includes a virtual camera 444, thus obviating the need for an encoder to be placed near the UC computer 210. This enables the UC computer 210 to be located in a variety of locations, whether in the conference room or remotely in a server rack. This flexibility is enabled by the computer manager 210 creating a virtual camera made available within the UC computer 430, where the UC computer 430 may transmit signals over the network, for example, from a server rack in a separate room from the conference room, to the decoder 530 connected to a shared display 130 or 131 located in the conference room. Further, the UC computer 430 may receive the camera streams remotely over the network to enable the virtual camera 444 within the UC computer 430.

Rather than requiring the virtual display to be routed to an encoder, which is connected to the display by a video cable, other embodiments only require an Ethernet and power cable and/or power over Ethernet cable for the UC computer 430 running the UC application 620 and compute manager 210, as described below.

FIG. 8 is a schematic, diagrammatic representation, in block diagram form, of an example videoconferencing room 800 with a virtualized hardware bridging system, in accordance with at least one embodiment of the present disclosure. As in FIG. 7, the room displays 130 are connected to the network video decoders 530 by video cables, and the network video decoders 530, touch screen controller 160, video cameras 120, microphones 150, and speakers 110 are all connected to the network.

Since the network (e.g., an Ethernet local area network or LAN) can extend beyond the videoconferencing room, the UC computer 430 and central processor 190 can be virtual machines 810 running on a server 820 located in a separate data room. The server 820 can support multiple UC computer instances 430 and central processors 190 simultaneously.

There may be a UC application and compute manager running on each virtual machine instance. Each virtual machine running the UC application and compute manager can serve, over the network, a different conference room and/or shared display and virtual camera. The total number of virtual machines can scale with the capabilities of the host server 820.

FIG. 9 is a schematic, diagrammatic representation, in block diagram form, an example videoconferencing room 900 with a virtualized hardware bridging system, in accordance with at least one embodiment of the present disclosure. As in FIGS. 7 and 8, the room displays 130 are connected to the network video decoders 530 by video cables, and the network video decoders 530, touch screen controller 160, video cameras 120, microphones 150, and speakers 110 are all connected to the local area network (LAN) 550.

As in FIG. 8, the UC computer 430 and central processor 190 can be virtual machines 810 running on a server 820, and the server 820 can support multiple UC computers 430 and central processors 190 simultaneously. However, in the example shown in FIG. 9, the server 820 running the virtual machines 810 is located remotely (e.g., in a data center or in the Cloud), and accesses the peripherals 110, 120, 130, 150, 160 530 on the LAN 550 via a network switch or router 170 that connects the LAN 550 to a wide area network (WAN) 910 such as the Internet, to which the server 820 is connected. Thus, the UC compute 430 does not need to be on the same premises as the videoconferencing room 900.

This architecture can support a large number of conference rooms with many instances of the compute manager, wherein all I/O is within the network and virtualized through a virtual machine version. The UC application and compute manager are paired on respective virtual machines.

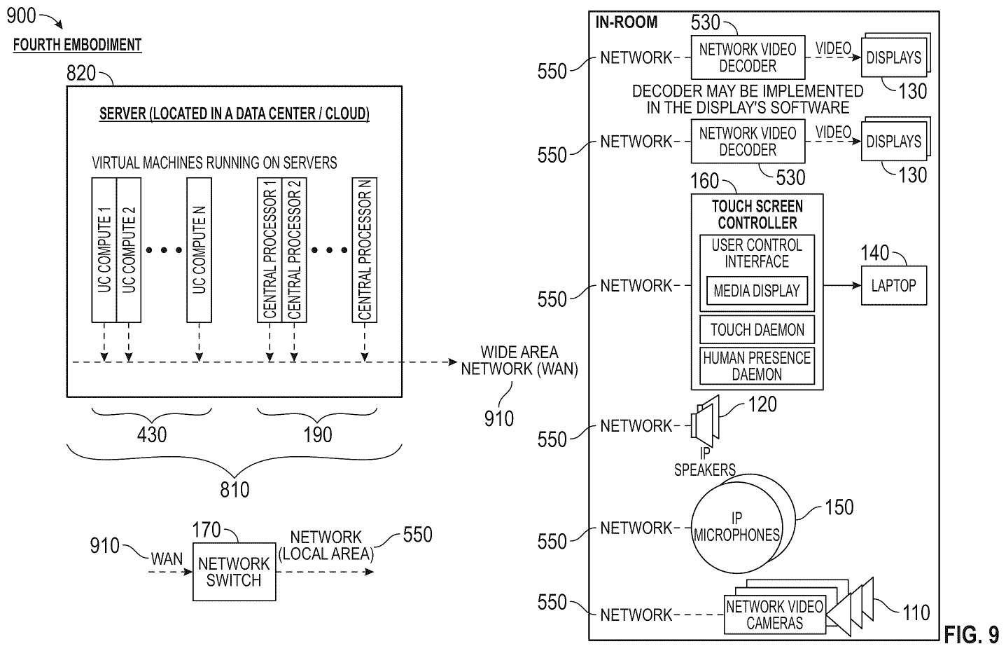

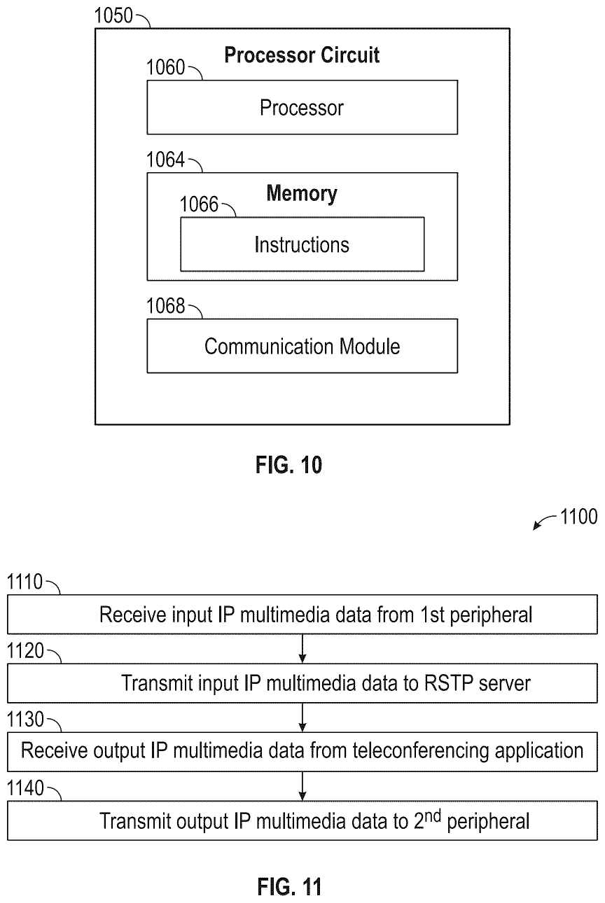

FIG. 10 is a schematic diagram of a processor circuit 1050, according to embodiments of the present disclosure. The processor circuit 1050 may be implemented in the UC computer 430, personal computer 140, touchscreen controller 160, central processing core 190, network switch or router 170, or other devices or workstations (e.g., third-party workstations, network encoders/decoders, etc.), or on a cloud processor or other remote processing unit, as necessary to implement the method. As shown, the processor circuit 1050 may include a processor 1060, a memory 1064, and a communication module 1068. These elements may be in direct or indirect communication with each other, for example via one or more buses.

The processor 1060 may include a central processing unit (CPU), a digital signal processor (DSP), an ASIC, a controller, or any combination of general-purpose computing devices, reduced instruction set computing (RISC) devices, application-specific integrated circuits (ASICs), field programmable gate arrays (FPGAs), or other related logic devices, including mechanical and quantum computers. The processor 1060 may also comprise another hardware device, a firmware device, or any combination thereof configured to perform the operations described herein. The processor 1060 may also be implemented as a combination of computing devices, e.g., a combination of a DSP and a microprocessor, a plurality of microprocessors, one or more microprocessors in conjunction with a DSP core, or any other such configuration.

The memory 1064 may include a cache memory (e.g., a cache memory of the processor 1060), random access memory (RAM), magnetoresistive RAM (MRAM), read-only memory (ROM), programmable read-only memory (PROM), erasable programmable read only memory (EPROM), electrically erasable programmable read only memory (EEPROM), flash memory, solid state memory device, hard disk drives, other forms of volatile and non-volatile memory, or a combination of different types of memory. In an embodiment, the memory 1064 includes a non-transitory computer-readable medium. The memory 1064 may store instructions 1066. The instructions 1066 may include instructions that, when executed by the processor 1060, cause the processor 1060 to perform the operations described herein. Instructions 1066 may also be referred to as code. The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may include a single computer-readable statement or many computer-readable statements.

The communication module 1068 can include any electronic circuitry and/or logic circuitry to facilitate direct or indirect communication of data between the processor circuit 1050, and other processors or devices. In that regard, the communication module 1068 can be an input/output (I/O) device. In some instances, the communication module 1068 facilitates direct or indirect communication between various elements of the processor circuit 1050, the virtualized hardware bridging system 200, and/or the videoconferencing rooms 100, 400, 500, 600, 700, 800, or 900. The communication module 1068 may communicate within the processor circuit 1050 through numerous methods or protocols. Serial communication protocols may include but are not limited to United States Serial Protocol Interface (US SPI), Inter-Integrated Circuit (I2C), Recommended Standard 232 (RS-232), RS-485, Controller Area Network (CAN), Ethernet, Aeronautical Radio, Incorporated 429 (ARINC 429), MODBUS, Military Standard 1553 (MIL-STD-1553), or any other suitable method or protocol. Parallel protocols include but are not limited to Industry Standard Architecture (ISA), Advanced Technology Attachment (ATA), Small Computer System Interface (SCSI), Peripheral Component Interconnect (PCI), Institute of Electrical and Electronics Engineers 488 (IEEE-488), IEEE-1284, and other suitable protocols. Where appropriate, serial and parallel communications may be bridged by a Universal Asynchronous Receiver Transmitter (UART), Universal Synchronous Receiver Transmitter (USART), or other appropriate subsystem.

External communication (including but not limited to communication over the wide area network) may be accomplished using any suitable wireless or wired communication technology, such as a cable interface such as a universal serial bus (USB), micro USB, Lightning, or FireWire interface, Bluetooth, Wi-Fi, ZigBee, Li-Fi, or cellular data connections such as 2G/GSM (global system for mobiles), 3G/UMTS (universal mobile telecommunications system), 4G, long term evolution (LTE), WiMax, or 5G. For example, a Bluetooth Low Energy (BLE) radio can be used to establish connectivity with a cloud service, for transmission of data, and for receipt of software patches. The compute manager 210 may be configured to communicate with a remote server, or a local device such as a personal computer 140, or may include a virtual display capable of showing status variables and other information. Information may also be transferred on physical media such as a USB flash drive or memory stick.

FIG. 11 shows a flow diagram of an example multimedia information exchange method 1100, according to at least one embodiment of the present disclosure. It is understood that the blocks of method 1100 may be performed in a different order than shown in FIG. 11, additional blocks can be provided before, during, and after the blocks, and/or some of the blocks described can be replaced or eliminated in other embodiments. One or more of blocks of the method 1100 can be carried by one or more devices and/or systems described herein, such as components of the UC computer 430, and/or processor circuit 1050.

In block 1110, the method 1100 includes receiving multimedia data from a first peripheral (e.g., a camera, microphone, touchscreen controller, or personal computer) via an IP interface or network connection of the UC computer. In various embodiments, the IP interface may be a wired or wireless local area network (e.g., Ethernet, Wi-Fi) or wide area network (e.g., the Internet).

For example, in some embodiments, the multimedia data may include compressed digital video in H.264 compression format, which is then transmitted using MPEG-2 transport packets over IP. In some embodiments, the IP format may include an uncompressed video format, e.g., IETF format specified in Request for Comments (RFC) 4175, or uncompressed video format specified by the Video Services Forum. In some embodiments, the IP format may include the UVC format for carriage of video over USB, which supports the carriage of both compressed and uncompressed video. Other examples of IP formats may include RTP using MPEG-2 compression, H.265 (High efficiency video coding HEVC), VP 8/9 video compression, MPEG-DASH or HLS streaming format, or other suitable format. The multimedia data may also include audio signals. Uncompressed audio formats consist of real sound waves captured and converted to digital format without further processing. They tend to be the most accurate but take up a lot of storage. Examples include PCM (Pulse-Code Modulation), WAV (Waveform Audio File Format), and AIFF (Audio Interchange File Format). Lossless compressed formats compress the audio data without losing information, so that the original audio can be reconstructed. Examples include FLAC, Monkey's Audio (.ape), WavPack (.wv), TTA, ATRAC Advanced Lossless, ALAC (.m4a), MPEG-4 SLS, MPEG-4 ALS, MPEG-4 DST, Windows Media Audio Lossless (WMA Lossless), and Shorten (SHN). Lossy compressed formats compress the audio data, but in a manner that loses some information, resulting in smaller file sizes. However, the original audio cannot be reconstructed perfectly. Examples include Opus, MP3, Vorbis, Musepack, AAC, ATRAC, and Windows Media Audio Lossy (WMA lossy). The multimedia data may additionally include commands, control messages, touch inputs, or other multimedia packets or events. The IP interface format may include the Open Network Video Interface Forum (ONVIF) protocol.

In block 1120, the method 1100 includes transmitting the input IP multimedia data, via a virtual hardware bridge, to an RTSP server of a virtual display running on the UC computer. The virtual display manager may, for example tell the RTSP server in virtual display where to send the audio, video, or control signals, e.g., to the displays or the touch screen controller.

In block 1130, the method 1100 includes receiving output IP multimedia data from a teleconferencing application running on the computing device via the virtual hardware bridge (e.g., via one or more of the drivers and managers of the compute manager). In some examples, such as in the case of the transmission of digital signage to displays on the network (e.g., displays 131), the computing device may not utilize the drivers or managers. However, in other instances (e.g., when the digital signage includes sound or video), the computing device may use one or more of the drivers and managers.

In block 1140, the method 1100 includes transmitting the output IP multimedia data to a second peripheral (e.g., a video display, camera, speaker, touchscreen controller, personal computer, or display) over the network via the network connection or IP interface.

These blocks may also be applied to a second peripheral, third peripheral, etc.

Flow diagrams are provided herein for exemplary purposes; a person of ordinary skill in the art will recognize myriad variations that nonetheless fall within the scope of the present disclosure. For example, any of the blocks described herein may optionally include an output to a user of information relevant to the block, and may thus represent an improvement in the user interface over existing art by providing information not otherwise available.

Similarly, the logic of flow diagrams may be shown as sequential. However, similar logic could be parallel, massively parallel, object oriented, real-time, event-driven, cellular automaton, or otherwise, while accomplishing the same or similar functions. In order to perform the methods described herein, a processor may divide each of the blocks described herein into a plurality of machine instructions, and may execute these instructions at the rate of several hundred, several thousand, several million, or several billion per second, in a single processor or across a plurality of processors. Such rapid execution may be necessary in order to execute the method in real time or near-real time as described herein. For example, in order for the videoconferencing software (e.g., Microsoft Teams Room, Zoom Rooms, etc.) to send video to the displays and receive video from the camera(s) in real time, it may be necessary for the compute manager to translate several hundred, several thousand, or several million signals, messages, or data packets per second.

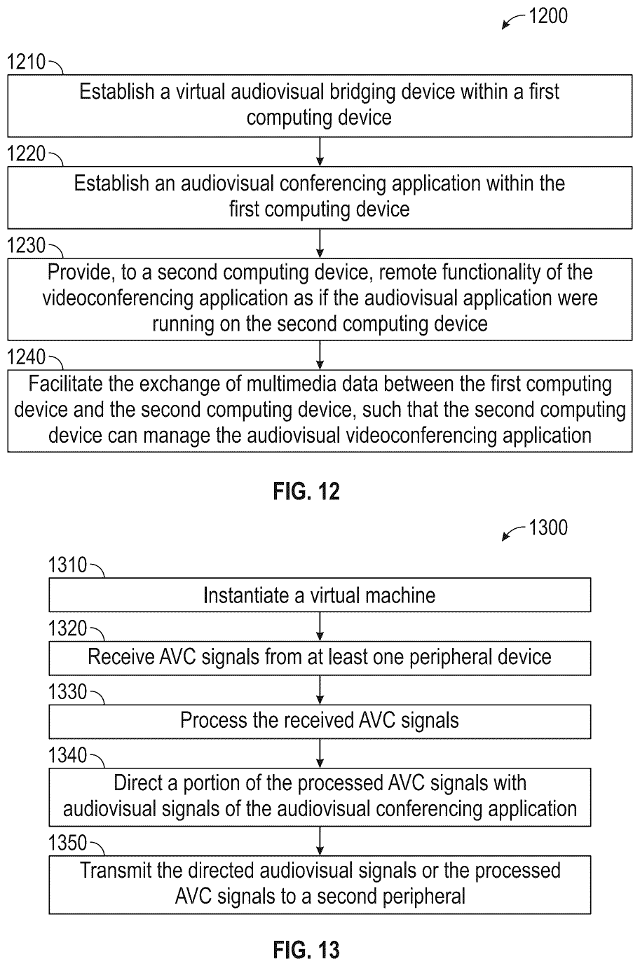

FIG. 12 shows a flow diagram of an example multimedia information exchange method 1200, according to at least one embodiment of the present disclosure.

In block 1210, the method 1200 includes establishing a virtual audiovisual bridging device (e.g., the compute manager) within a first computing device such as a server. In an example of block 1210, a virtual audiovisual bridging device may be downloaded to the computing device. In an example of block 1210, the first computing device may be a server housed within a data center remote from a location (e.g., within a conference room) where a second computing device is located. In another example of block 1210, the first computing device may be a server housed on-premises within an IT room of a large commercial facility and remote from a number of conference rooms within the commercial building, one or more of the conference rooms including an AVC setup comprising peripheral devices that transmit/receive signals to/from the first computing device.

In block 1220, the method 1200 includes establishing an audiovisual conferencing application such as MTR or ZR within the first computing device. In one example of block 1220, the audiovisual conferencing application may be downloaded to the first computing device.

In block 1230, the method 1200 includes providing, to a second computing device, remote functionality of the videoconferencing application, as if the audiovisual application were running on the second computing device. In one example of block 1230, second computing device (e.g., touch-screen controller 160, along with other peripherals 110-150), may transmit/receive signals to/from first computing device (e.g., UC compute 430 or central processor 190) over networks 550 and 910.

In one example of block 1230, although PC Application (e.g., MTR, ZR, and so on) is running on server 820, the touch screen controller 160 may be able to provide functionality within a graphical user interface (e.g., media display) to a user such that the user may control PC Applications 610 via touch screen controller 160. For example, virtual touch 372 may receive signals inputted within media display, for example by a user, and transmitted by touch daemon over networks 550, 910. The received signals, managed by virtual touch manager 436 and virtual display manager 438, may be fed to RTSP Server 362, and then transmitted over networks to either or both of touch screen controller 160 and network video decoders 530 for display within room displays 130.

In block 1240, the method 1200 includes facilitating the exchange of multimedia data between the first computing device and the second computing device, such that the second computing device can manage the audiovisual videoconferencing application. This remote functionality may for example allow a user sitting remote from the server to control an application such as MTR or ZR from a laptop (e.g., laptop 140) or touchscreen controller 160.

FIG. 13 shows a flow diagram of an example multimedia information exchange method 1300, according to at least one embodiment of the present disclosure.

In block 1310, the method 1300 includes instantiating a virtual machine on a computing device such as a server. The virtual machine runs a virtual audiovisual bridging component and an audiovisual conferencing application.

In block 1320, the method 1300 includes, with the virtual audiovisual bridging component, receiving (e.g., over a network, via a set of virtual peripheral drivers) audio, video, and control (AVC) signals from at least one peripheral device located remotely from the server. In an example of block 1320, the computing device may be receiving audio, video, and/or control signals from a second peripheral, for example located within a second location (e.g., within a second conference room), remote from both the computing device and the first peripheral.

In block 1330, the method 1300 includes, with the virtual audiovisual bridging component, processing the received AVC signals. Processing may for example include gain and level adjustments, acoustic echo reduction or cancellation, mixing, encoding/decoding, resolution adjustments, cropping, delay control, voice over internet protocol/session initiation protocol (VOIP/SIP) interface control, input control, etc.

In block 1340, the method 1300 includes directing, via the virtual audiovisual bridging component, a portion of the processed AVC signals with audiovisual signals of the audiovisual conferencing application via the RTSP servers (e.g., to one or more displays).

In block 1350, the method 1300 includes transmitting, via the virtual audiovisual bridging component, the directed audiovisual signals or the processed AVC signals to a second peripheral located remotely from the server.

Accordingly, it can be seen that the virtualized hardware bridging system advantageously eliminates the need for a hardware bridge between, for example, USB and Ethernet connections and signals, (or other peripheral bus and IP network connections and signals) in videoconferencing rooms, by allowing such bridging to be performed internally to the UC computer that is running the videoconferencing software.

A number of variations are possible on the examples and embodiments described above. For example, the technology described herein can be applied to multiple videoconferencing rooms at once, whether in the same building or across multiple buildings, and can also be applied to more complex audiovisual systems, including soundstages, amphitheaters, recording studios, etc.

The technology described herein may be applied to UC computers of various types, including but not limited to servers, desktop computers, laptop and notebook computers, tablets, or smartphones, and virtual computers running operating systems such as Windows, MacOS, Linux, IOS, Android, etc.

Accordingly, the logical operations making up the embodiments of the technology described herein are referred to variously as operations, steps, blocks, objects, elements, components, or modules. Furthermore, it should be understood that these may occur or be performed or arranged in any order, unless explicitly claimed otherwise or a specific order is inherently necessitated by the claim language.

All directional references e.g., upper, lower, inner, outer, upward, downward, left, right, lateral, front, back, top, bottom, above, below, vertical, horizontal, clockwise, counterclockwise, proximal, and distal are only used for identification purposes to aid the reader's understanding of the claimed subject matter, and do not create limitations, particularly as to the position, orientation, or use of the virtualized hardware bridging system. Connection references, e.g., attached, coupled, connected, joined, or “in communication with” are to be construed broadly and may include intermediate members between a collection of elements and relative movement between elements unless otherwise indicated. As such, connection references do not necessarily imply that two elements are directly connected and in fixed relation to each other. The term “or” shall be interpreted to mean “and/or” rather than “exclusive or.” The word “comprising” does not exclude other elements or steps, and the indefinite article “a” or “an” does not exclude a plurality. Unless otherwise noted in the claims, stated values shall be interpreted as illustrative only and shall not be taken to be limiting.

Methods and embodiments described herein further relate to any one or more of the following paragraphs:
1. A computer-implemented method for remotely facilitating exchange of multimedia signals over a network in a teleconferencing environment, the method comprising: with a computing device, in real time: receiving input internet protocol (IP) signals from a first peripheral over the network via an IP interface of the computing device; transmitting the input IP signals, via a virtual hardware bridge, to a real-time streaming protocol (RTSP) server of a virtual display running on the computing device; receiving one or more output IP signals from a teleconferencing application running on the computing device via the virtual hardware bridge; and transmitting the output IP signals to a second peripheral over the network.
2. The method of paragraph 1, wherein the virtual hardware bridge comprises a virtual soundcard manager configured to communicate with a virtual sound driver running on the computing device; a virtual camera manager configured to communicate with a virtual camera driver running on the computing device; a virtual touch manager configured to communicate with a virtual touch driver running on the computing device; and a virtual display manager configured to communicate with a virtual display driver running on the computing device or a real-time streaming protocol (RTSP) server running on the computing device.
3. The method of paragraphs 1 or 2, wherein the first peripheral and the second peripheral are a single peripheral.
4. The method of any of paragraphs 1-3, wherein the single peripheral comprises a personal computing device or mobile device.
5. The method of any of paragraphs 1-4, wherein the single peripheral comprises a touchscreen controller, wherein the input IP signals are touch signals, and wherein the output IP signals are touchscreen controller video signals.
6. The method of any of paragraphs 1-5, wherein the single peripheral comprises a camera, wherein the input IP signals comprise input video signals, and wherein the output IP signals comprise camera control commands to an IP interface of the camera.
7. The method of any of paragraphs 1-6, wherein the input video signals are compliant with at least one of an H.264 format, Motion Picture Experts Group (MPEG) format, Internet Engineering Task Force (IETF) format specified in Request for Comments (RFC) 4175, or Video Services Forum uncompressed format.
8. The method of any of paragraphs 1-7, wherein the first peripheral comprises a microphone, and wherein the input IP signals comprise audio input signals.
9. The method of any of paragraphs 1-8, wherein the second peripheral comprises a speaker, and wherein the output IP signals comprise audio output signals.
10. The method of any of paragraphs 1-9, wherein the second peripheral comprises a display or network video decoder, and wherein the output IP signals comprise video output signals.
11. The method of any of paragraphs 1-10, wherein the video output signals are compliant with at least one of an H.264 format, Motion Picture Experts Group (MPEG) format, Internet Engineering Task Force (IETF) format specified in Request for Comments (RFC) 4175, or Video Services Forum uncompressed format.
12. The method of any of paragraphs 1-11, wherein the computing device is a virtual machine running on a server.
13. The method of any of paragraphs 1-12, wherein the network is a local area network, and wherein the server is configured to access the local area network via a wide area network.
14. The method of any of paragraphs 1-13, wherein the server is located in a data center that is not co-located with the first peripheral and the second peripheral.
15. A computer-implemented method, comprising: with a server: instantiating a virtual machine running on the server, the virtual machine including a virtual audiovisual bridging component and an audiovisual conferencing application; with the virtual audiovisual bridging component: receiving, over a network, audio, video, control (AVC) signals from at least one first peripheral device located remotely from the server; processing the received AVC signals; directing, via the virtual audiovisual bridging component, a portion of the processed AVC signals with audiovisual signals of the audiovisual conferencing application; and, transmitting, via the virtual audiovisual bridging component, the directed audiovisual signals or the processed AVC signals to a second peripheral located remotely from the server.
16. The method of paragraph 15, wherein the at least one first peripheral device and the second peripheral device are a single peripheral.
17. The method of paragraphs 15 or 16, wherein the single peripheral comprises a camera, wherein the received AVC signals comprise input video signals, and wherein the directed audiovisual signals or the processed AVC signals comprise camera control commands to an IP interface of the camera.
18. The method of any of paragraphs 15-17, wherein the at least one first peripheral device comprises a microphone, and wherein the received AVC signals comprise audio input signals.
19. The method of any of paragraphs 15-18, wherein the second peripheral device comprises a speaker, and wherein the directed audiovisual signals or the processed AVC signals comprise audio output signals.
20. A virtual hardware bridge configured to: with a computing device, in real time: transmit input IP signals to an RTSP server of a virtual display running on the computing device; and receive one or more output IP signals from a teleconferencing application running on the computing device, wherein the virtual hardware bridge comprises: a virtual soundcard manager configured to communicate with a virtual sound driver running on the computing device; a virtual camera manager configured to communicate with a virtual camera driver running on the computing device; a virtual touch manager configured to communicate with a virtual touch driver running on the computing device; and a virtual display manager configured to communicate with a virtual display driver running on the computing device or a real-time streaming protocol (RTSP) server running on the computing device.
21. A computer-implemented method for remotely facilitating exchange of multimedia signals over a network in a teleconferencing environment, the method comprising: with a computing device, in real time: receiving input internet protocol (IP) signals from a first peripheral over the network via an IP interface of the computing device; transmitting the input IP signals, via a virtual hardware bridge, to a real-time streaming protocol (RTSP) server of a virtual display running on the computing device; receiving one or more output IP signals from a teleconferencing application running on the computing device via the virtual hardware bridge, the output IP signals comprising digital signage; and transmitting the output IP signals to a second peripheral over the network via the network connection, wherein the digital signage is displayed on the second peripheral.
22. The method of paragraph 21, wherein the second peripheral comprises a personal computing device.
23. The method of paragraphs 21 or 22, wherein the second peripheral comprises a mobile device.
24. The method of any of paragraphs 21-23, wherein the second peripheral comprise a touchscreen controller.
25. The method of any of paragraphs 21-14, wherein the second peripheral is a display located in inside a building, outside a building or along a roadway.

The above specification, examples and data provide a complete description of the structure and use of exemplary embodiments of the virtualized hardware bridging system as defined in the claims. Although various embodiments of the claimed subject matter have been described above with a certain degree of particularity, or with reference to one or more individual embodiments, those skilled in the art could make numerous alterations to the disclosed embodiments without departing from the spirit or scope of the claimed subject matter.

Still other embodiments are contemplated. It is intended that all matter contained in the above description and shown in the accompanying drawings shall be interpreted as illustrative only of particular embodiments and not limiting. Changes in detail or structure may be made without departing from the basic elements of the subject matter as defined in the following claims.

What is claimed is:

1. A computer-implemented method for remotely facilitating exchange of multimedia signals over a network in a teleconferencing environment, the method comprising:
with a computing device, in real time:
receiving input internet protocol (IP) signals from a first peripheral over the network via an IP interface of the computing device;
transmitting the input IP signals, via a virtual hardware bridge, to a real-time streaming protocol (RTSP) server of a virtual display running on the computing device;
receiving one or more output IP signals from a teleconferencing application running on the computing device via the virtual hardware bridge; and
transmitting the output IP signals to a second peripheral over the network.

2. The method of claim 1, wherein the virtual hardware bridge comprises:
a virtual soundcard manager configured to communicate with a virtual sound driver running on the computing device;
a virtual camera manager configured to communicate with a virtual camera driver running on the computing device;
a virtual touch manager configured to communicate with a virtual touch driver running on the computing device; and
a virtual display manager configured to communicate with a virtual display driver running on the computing device or a real-time streaming protocol (RTSP) server running on the computing device.

3. The method of claim 1, wherein the first peripheral and the second peripheral are a single peripheral.

4. The method of claim 3, wherein the single peripheral comprises a personal computing device or mobile device.

5. The method of claim 3, wherein the single peripheral comprises a touchscreen controller, wherein the input IP signals are touch signals, and wherein the output IP signals are touchscreen controller video signals.

6. The method of claim 3, wherein the single peripheral comprises a camera, wherein the input IP signals comprise input video signals, and wherein the output IP signals comprise camera control commands to an IP interface of the camera.

7. The method of claim 6, wherein the input video signals are compliant with at least one of an H.264 format, Motion Picture Experts Group (MPEG) format, Internet Engineering Task Force (IETF) format specified in Request for Comments (RFC) 4175, or Video Services Forum uncompressed format.

8. The method of claim 1, wherein the first peripheral comprises a microphone, and wherein the input IP signals comprise audio input signals.

9. The method of claim 1, wherein the second peripheral comprises a speaker, and wherein the output IP signals comprise audio output signals.

10. The method of claim 1, wherein the second peripheral comprises a display or network video decoder, and wherein the output IP signals comprise video output signals.

11. The method of claim 10, wherein the video output signals are compliant with at least one of an H.264 format, Motion Picture Experts Group (MPEG) format, Internet Engineering Task Force (IETF) format specified in Request for Comments (RFC) 4175, or Video Services Forum uncompressed format.

12. The method of claim 1, wherein the computing device is a virtual machine running on a server.

13. The method of claim 12, wherein the network is a local area network, and wherein the server is configured to access the local area network via a wide area network.

14. The method of claim 13, wherein the server is located in a data center that is not co-located with the first peripheral and the second peripheral.

15. A computer-implemented method, comprising:
with a server:
instantiating a virtual machine running on the server, the virtual machine including a virtual audiovisual bridging component and an audiovisual conferencing application;
with the virtual audiovisual bridging component:
receiving, over a network, audio, video, control (AVC) signals from at least one first peripheral device located remotely from the server;
processing the received AVC signals;
directing, via the virtual audiovisual bridging component, a portion of the processed AVC signals with audiovisual signals of the audiovisual conferencing application; and,
transmitting, via the virtual audiovisual bridging component, the directed audiovisual signals or the processed AVC signals to a second peripheral located remotely from the server.

16. The method of claim 15, wherein the at least one first peripheral device and the second peripheral device are a single peripheral.

17. The method of claim 16, wherein the single peripheral comprises a camera, wherein the received AVC signals comprise input video signals, and wherein the directed audiovisual signals or the processed AVC signals comprise camera control commands to an IP interface of the camera.

18. The method of claim 15, wherein the at least one first peripheral device comprises a microphone, and wherein the received AVC signals comprise audio input signals.

19. The method of claim 15, wherein the second peripheral device comprises a speaker, and wherein the directed audiovisual signals or the processed AVC signals comprise audio output signals.

20. A virtual hardware bridge configured to:
with a computing device, in real time:
transmit input IP signals to an RTSP server of a virtual display running on the computing device; and
receive one or more output IP signals from a teleconferencing application running on the computing device,
wherein the virtual hardware bridge comprises:
a virtual soundcard manager configured to communicate with a virtual sound driver running on the computing device;
a virtual camera manager configured to communicate with a virtual camera driver running on the computing device;
a virtual touch manager configured to communicate with a virtual touch driver running on the computing device; and
a virtual display manager configured to communicate with a virtual display driver running on the computing device or a real-time streaming protocol (RTSP) server running on the computing device.

21. A computer-implemented method for remotely facilitating exchange of multimedia signals over a network in a teleconferencing environment, the method comprising:
with a computing device, in real time:
receiving input internet protocol (IP) signals from a first peripheral over the network via an IP interface of the computing device;
transmitting the input IP signals, via a virtual hardware bridge, to a real-time streaming protocol (RTSP) server of a virtual display running on the computing device;
receiving one or more output IP signals from a teleconferencing application running on the computing device via the virtual hardware bridge, the output IP signals comprising digital signage; and
transmitting the output IP signals to a second peripheral over the network via the network connection, wherein the digital signage is displayed on the second peripheral.

22. The method of claim 21, wherein the second peripheral comprises a personal computing device.

23. The method of claim 21, wherein the second peripheral comprises a mobile device.

24. The method of claim 21, wherein the second peripheral comprise a touchscreen controller.

25. The method of claim 21, wherein the second peripheral is a display located in inside a building, outside a building or along a roadway.
